(19) United States
(12) Patent Application Publication
(10) Pub. No.: US 2006/0210048 A1
(43) Pub. Date: Sep. 21, 2006

(54) Method and system for generating a generic test plan for network based telephony systems

(75) Inventors: Richard Whitehead, San Francisco, CA (US); Kevin McGowan, Monument, CO (US); David Roberts, El Cerrito, CA (US)

Correspondence Address: HAYNES BEFFEL & WOLFELD LLP, P O BOX 366, HALF MOON BAY, CA, 94019, US

(73) Assignee: Clarus Systems, Inc., San Francisco, CA (US)

(21) Appl. No.: 11/372,944

(22) Filed: Mar. 10, 2006

Related U.S. Application Data
(60) Provisional application No. 60/660,326, filed on Mar. 11, 2005.

(51) Int. Cl. H04M 1/24; H04M 7/00

(52) U.S. Cl. 379/221.09; 379/1.01

(57) ABSTRACT

Assembling a generic system for testing a network-based telephony system. The process begins by abstracting required performance characteristics of a network-based telephony system. For each functional element of abstracted characteristics, the system separates generic characteristics from implementation-specific performance characteristics of the network; the system proceeds by constructing test components addressing each functional element;, and then it assembles the test components into a unified set, including enabling configuration of each template to accommodate specific network implementations.

### RELATED APPLICATION

This application is related to U.S. patent application No.______, entitled “Implementing a Test Regime for a Network Based Telephony System” filed on 10 Mar. 2006 by Douglas Conklin, Kevin McGowan, Jeff Kemper and Kalman Lau. The related application is incorporated by reference.

This application claims the benefit of U.S. Provisional Patent Application No. 60/660,326, entitled “Dynamic Identification and Allocation of Resources and Encapsulation of Test Intent in an Automated Test System” filed on 11 Mar. 2005 by Kevin McGowan, Eric Weise, Kamal Shah, Tony Mowers, Jeff Kemper, Kalman Lau, Douglas Conklin, Suleman Alam, Richard Whitehead and David Roberts. That application is incorporated by reference for all purposes.

### BACKGROUND OF THE INVENTION

The present invention relates to test systems. In particular, it relates to test systems and regimes for network-based telephony systems.

Testing private telephony systems generally amounts to placing a series of calls to determine the availability and quality of service. Telephone service providers have sophisticated systems for testing their overall networks, of course, but testing a system installed in an office building, for example, or with a multi-building campus is left to the purchaser.

The nature of network-based telephone systems makes the test problem more serious. This technology is often referred to as voice-over-internet-protocol (VoIP or Voice-over-IP), or as IP Telephony. Because the system is based on packet transmissions over whate4ver network path is optimal and available at a given moment, rather than establishing a dedicated, physical circuit, testing must be much more a part of everyday activity, and quality must be monitored more carefully than is the case for conventional systems.

A number of vendors have offered equipment to this area, primarily Agilent, Radcom and Mercury Interactive, yet no offering has appeared to present a complete solution to system installers and owners. The art thus continues to seek a system for providing a completely automated solution to the testing problem.

### SUMMARY OF THE INVENTION

Assembling a generic system for testing a network-based telephony system. The process begins by abstracting required performance characteristics of a network-based telephony system. For each functional element of abstracted characteristics, the system separates generic characteristics from implementation-specific performance characteristics of the network. The system proceeds by constructing test components addressing each functional element, and then it assembles the test components into a unified set, including enabling configuration of each template to accommodate specific network implementations

### BRIEF DESCRIPTION OF THE DRAWINGS

FIG. 1 illustrates a network-based telephony system as is known in the art.

FIG. 2 illustrates a network-based telephony system employing the test system of the present invention.

FIG. 3 depicts an embodiment of the system test process of the present invention.

FIG. 4 illustrates the workflow involved in the course of practicing an embodiment of the present invention.

FIG. 5 depicts the individual functions that could be included in a test plan under the present invention.

FIG. 6 depicts the grouping of individual functions into categories for analysis purposes, according to an embodiment of the present invention.

FIG. 7 illustrates an embodiment of the present invention in use, during assembly of functional elements into a test plan.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

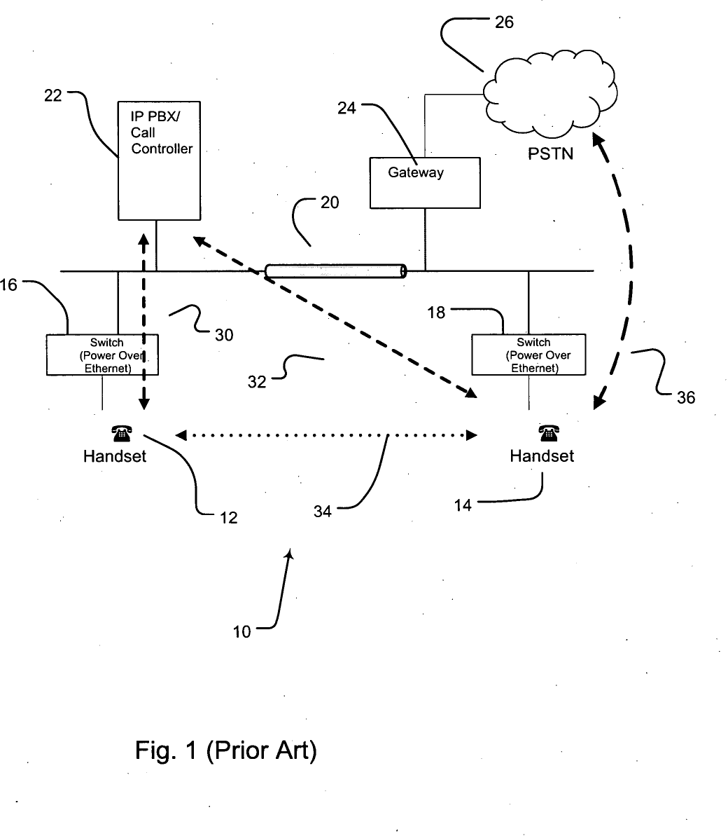

FIG. 1 illustrates a typical network-based telephony system. The term network-based, as known in the art, implies a telephony system that employs technology variously referred to as “IP telephony” or “voice over IP.” The fundamental difference between that technology and conventional telephony systems is that the latter features communication over a dedicated, physically established circuit. That is, a call is initiated by establishing a physical circuit between the parties, and that circuit remains so dedicated until the call is terminated. A network-based system, in contrast, follows the internet, or more accurately the internet protocol (IP) approach of breaking a communication into packets, each of which may follow a different communication path and are reassembled at the receiving end. The basic technology is well known and will not be described here in greater detail, but it should be understood that the cost advantages of a network-based approach are considerable.

In a typical network-based system 10, an individual handset 12 is connected to a network 20 via an interface switch 16. The network is preferably a conventional Ethernet or similar system. The switch accepts standard telephone handset connectors and is, from the user's perspective, identical to a connection to a conventional telephone system. Just as connections in a private closed system, such as an office building or company, are run through a private branch exchange (PBX), the local portion of a network-based system is controlled by an IP PBX 22. These devices are well-known in the art and are commercially available from suppliers such as Cisco Systems, Inc. and others. In a typical example, when the user of handset 12 wishes to place a call to the user of handset 14, the IP PBX signals each handset directly, via signals 30 and 32, with the result that an audio path 34 is created. Again, this explanation is presented by way of background and will not be elaborated here. It is preferred to employ a protocol such as the Real Time Protocol (RTP) in such a communication, but those in the art may implement a system in a number of ways.

Calls may be placed out of and into a network-based telephony system from the conventional telephone systems, usually referred to as the Public Switched Telephone Network (PSTN). Such calls pass through a gateway 24, which sets up an audio path 36. It bears repeating that the technology is completely transparent to the user, who is generally not aware of the nature of the system or its interface with the conventional network.

It can be easily appreciated that a network-based system will be much more difficult to test and implement that is a conventional system. A conventional system is readily set up and tested, because each connection is permanently wired. A network-based system must adapt to a network, which requires adaptation to the system involved and the particular network topology. In the conventional environment, quality is straightforwardly obtained, and once achieved is not likely to degrade. Just the opposite is true of a network-based system. Here, configuration is key, and quality must not only be achieved, but it also must be monitored continually.

Testing telephony systems is important from two aspects. First, the network must be certified for proper operation before commencing live operation. Often the certification requirements will be incorporated into the installation contract. Following the go-live point, testing must be performed continually, in order to ensure that quality and responsiveness characteristics are being met. Unlike a conventional system, a network-based system is much more vulnerable to external problems, principally involving the network. Also, the nature of the system present entire classes of potential problems, such as correct packet re-assembly, that are not present on conventional systems.

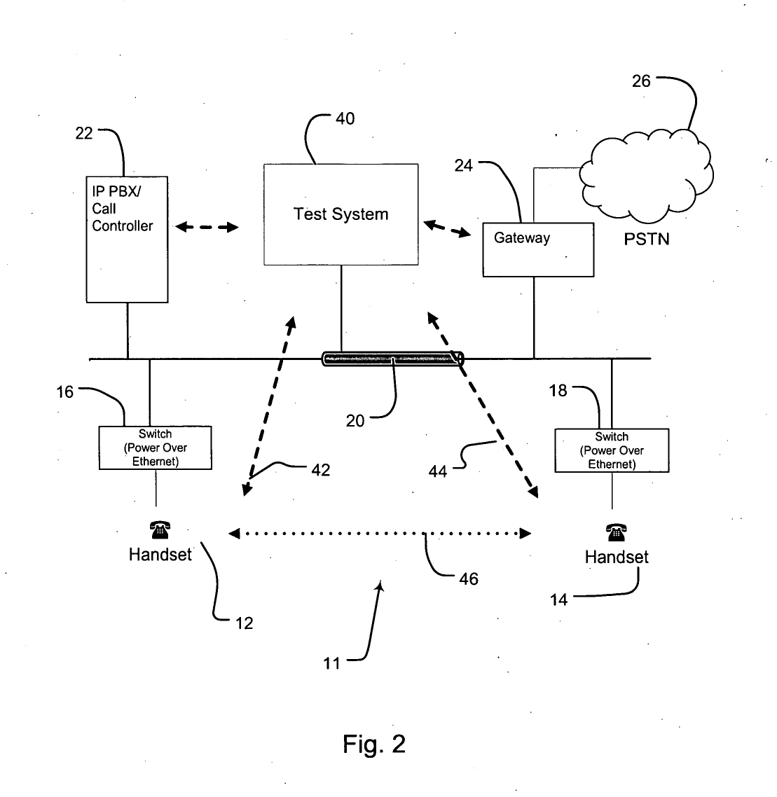

A network-based telephony system incorporating a test system based on the present invention is shown in FIG. 2. There, the test system 40 is interfaced directly to the network 20. In operation, the test system takes control of the calling process, such as, for example, between handsets 12 and 14, via network signals 42 and 44, establishing audio path 46 between the calling devices.

Test system 40 executes a test plan for a particular network-based system. As noted above, each network-based system is different, requiring considerably more customization in developing a test plan than would be true for a conventional system.

It is understood by those in the art that test planning involves a number of preliminary considerations. Equipment selection and installation must precede system testing, of course, and it is presumed that a suitable call control system is installed and is operational within the bounds of the local network. Such systems are available from a number of sources, but for purposes of explanation here, it will be assumed that the network employs the Cisco Call Manager (CCM) system.

Specifically, the following steps are all prerequisites to implementation of a system test plan. First, network topology must be laid out, with appropriate unit clusters defined. Then, the control system, such as CCM (one or more), must be installed, and connectivity to the defined clusters must be established and tested, including synchronization with whatever database and inventory resources that may be required. Finally, a system phonebook must be available, including whatever PSTN numbers are desired. At that point, with the network operational internally, a test plan can be devised and implemented.

As noted above, it is highly desirable to have a generic test plan that can be customized readily to fit a particular situation. Development of a generic test plan begins with identifying specific network functionality that requires testing in order to assure proper overall network performance. Having identified a function, it remains to add required information, conditions and objects that convert a function into a test regime that exercises that function. Then the specific tests must be assembled into a test plan.

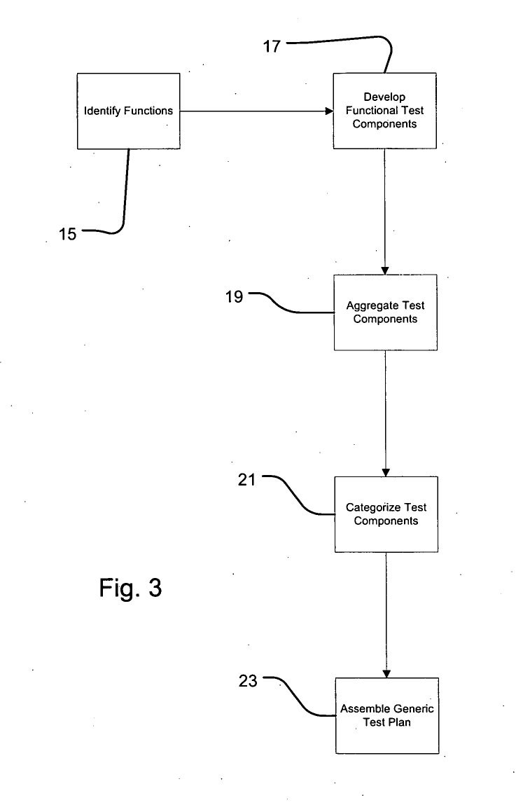

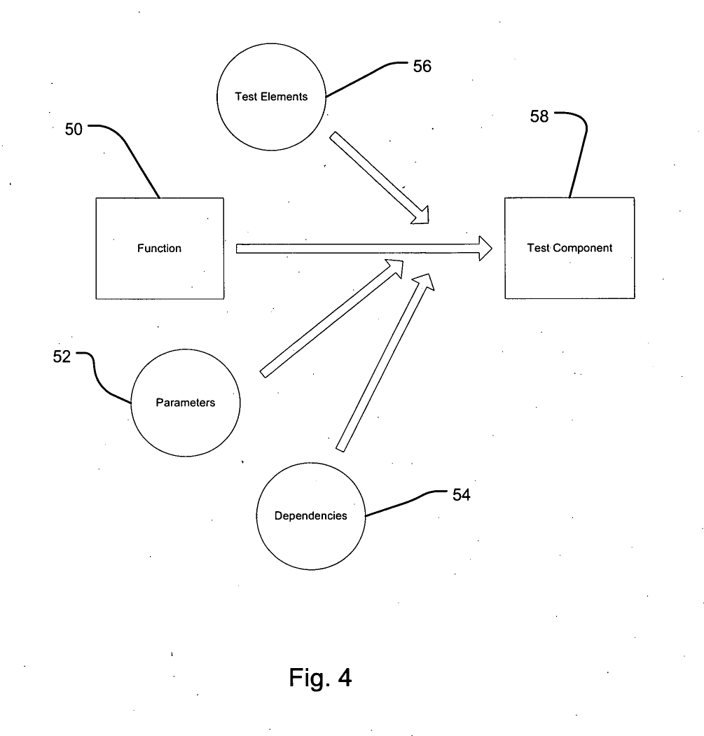

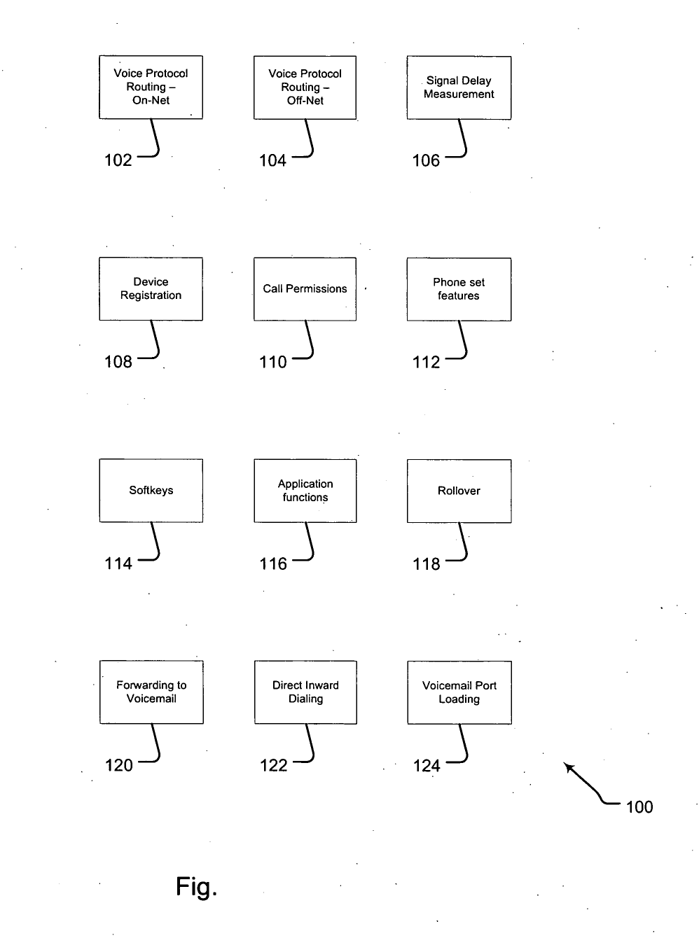

FIG. 3 sets out an embodiment of a process for progressing from a function to a test plan. First, in step 15, the specific function is identified, and in step 17 the function is incorporated into a test component that tests that specific function. The details for that step are set out in connection with FIG. 4, below. Then, in step 19, after all desired network functions are identified and test components developed, the test components are aggregated into an overall structure, discussed below in connection with FIG. 5. Finally, the test components are categorized in step 21 and assembled into a generic test plan, ready for customization to fit a specific situation.

The process for developing a test component from an identified function is shown in FIG. 4. In general, a network function requiring test and evaluation is identified, in step 50. To that function are added a number of factors, such as function parameters 52, dependencies 54 and test elements 56, all of which combine to produce a test component 58.

This process can better be understood by considering a specific example, the function of verifying a voice protocol, which allows verification of routing required voice protocols over various network paths in the deployment. Here, operation both on the specific network must be considered, such as between related office buildings, campuses or branch offices, as well as interface with the PSTN system. These two modes are referred to as “On Net” and “Off Net,” respectively. A path is defined by two endpoints, which can either network segments, locations or device pools. For example, if one planned to test connectivity between two branch offices, using WAN links, the location form of the test might be most appropriate, assuming phones in each branch office have a unique location. On the other hand, for single-site campus deployments, either the device pool or network segment forms of the test con provide the granularity necessary to certify communications between portions of the network. An actual test consists of randomly selecting an originating phone from one side and a terminating phone from the other. Because the system is software controlled, a call can actually be made without involving the user, and the connection can be verified.

Test parameters (item 52, FIG. 4) are variables that in the conduct of the test itself, as opposed to qualities being measured. Here, a primary test parameter is the connection timeout period, the amount of time that the system waits for a connection to be established. Here the actual elapsed time to connection is an important measure of quality, and it is indeed measured. The timeout setting is a test parameter that can be varied in order to ensure efficient conduct of the test. Another common parameter is the sampling rate—the rate (most usually times per second) at which the system repeats the test. As will be easily understood, a higher sampling rate yields a more reliable test indicator. In general, test parameters include minimum, maximum and default values.

Test elements (item 56, FIG. 4) concern what portions of a network, and what equipment, are subjected to test. The specifics of that determination must await the customization for a specific network and site, of course, but desired types of testing can be specified ahead of time, allowing for resource planning and allocation. For the voice protocol testing, for example, it is desirable to test between and among different network segments, different locations, and different device pools, for example. Without thinking about specific instances of each type of communication, each of these potential test elements involves a different type of network operation, and thus each must be tested if the system as a whole is to be evaluated. A generic approach can be set out for defining test call end points randomly, the call procedure, and the measurements to made.

In addition, each function must be evaluated in terms of dependencies (item 54, FIG. 4), the preliminary considerations that must be allocated and configured before running a test. For the voice protocol example, all on-net testing must deal with on-net resource constraints, which limit the network resources that can be taken out of service for testing at any given time. Similarly, off-net tests must have the phone book available, for PSTN access, as well as resource constraints.

The desired test function is considered together with test elements, parameters and dependencies to derive a test component 58 (FIG. 4). The latter is a complete description of a procedure for testing a desired network characteristic, including a process for addressing a particular network in terms of the specific test elements and dependencies, as discussed above.

Developing a comprehensive generic test plan requires repeating the analysis set out above for all desired functions, followed by aggregating the resulting test components (step 19, FIG. 3). Such an aggregation is shown in FIG. 5, which depicts a typical set of test components. It will be helpful to consider each component at least in some detail. The first two, voice protocol routing on-net component 102 and off-net off-net component 104, are discussed above.

Signal delay measurement component 106 determines whether a specific phone to send a request for service to its CCM and receive a dial tone within a specified time period. That measure is important in a network-based system due to network and IP issues.

Device registration component 108 ensures that a specific phone can register to its primary CCM via SCCP. In embodiments that do not employ the Cisco Call Manager, the system would employ the appropriate protocol, as known in the art. This is not a test of phone registration status, but rather measure communications quality between a phone and the CCM.

The call permissions component 110 ensures that a particular phone is actually either blocked or allowed to execute particular off-network dialing strings, as defined in the system phone book. For example, some telephones may not be cleared for long-distance, or off-campus, calls. This test ensures that such status is being enforced.

The directory handler lookup component 112 verifies that the directory handler function, which allows dialing by extension within defined groups, actually allows users to reach specified extensions with short dialup strings. Here, phones in a group are systematically tested to ensure that they respond to shortened dial numbers.

Softkey functions component 114 tests operations of defined softkey (function key) operations for particular phones. Because these functions are implements in software run away from the phone, they must be tested. Functions can be chosen as desired, but common choices include call hold, redial, call park, call transfer, the corporate directory, and conferencing.

The rollover component 118 ensures that the system is able to transfer calls from a phone's primary number to some other number, or to a second line on the same phone when the first line is busy.

The meet-me conference component 116 tests the function allows a number of users to dial a preset number to participate in a conference call. The component tests participation of random numbers of callers into a conference session for varying lengths of time, including tests that saturate the conference capability.

Forward to voicemail, component 120, tests whether a failure to answer a given line, or if chosen, all calls, generate a transfer to a voicemail system, or to some number that is automatically answered.

Direct inward dialing allows a system phone to be assigned a DID PSTN number, and component 122 tests that function by dialing the PSTN number from a system phone, traversing the gateway, hairpin and the local Central Office, and then return to the network, ringing the target line.

Finally, voicemail port loading component 124 tests the ability of the voicemail system to handle high loads, and the proper configuration of the CCM, as well as the functioning of the last available port to forward further calls to the receptionist line.

It must be emphasized that the steps discussed above are detailed implementations in a single embodiment of a test plan based on the present invention. In other environments, and particularly as the underlying technology develops, many of the details of the tests set out here will be changed. All such changes can be made without departing from the scope and spirit of the invention.

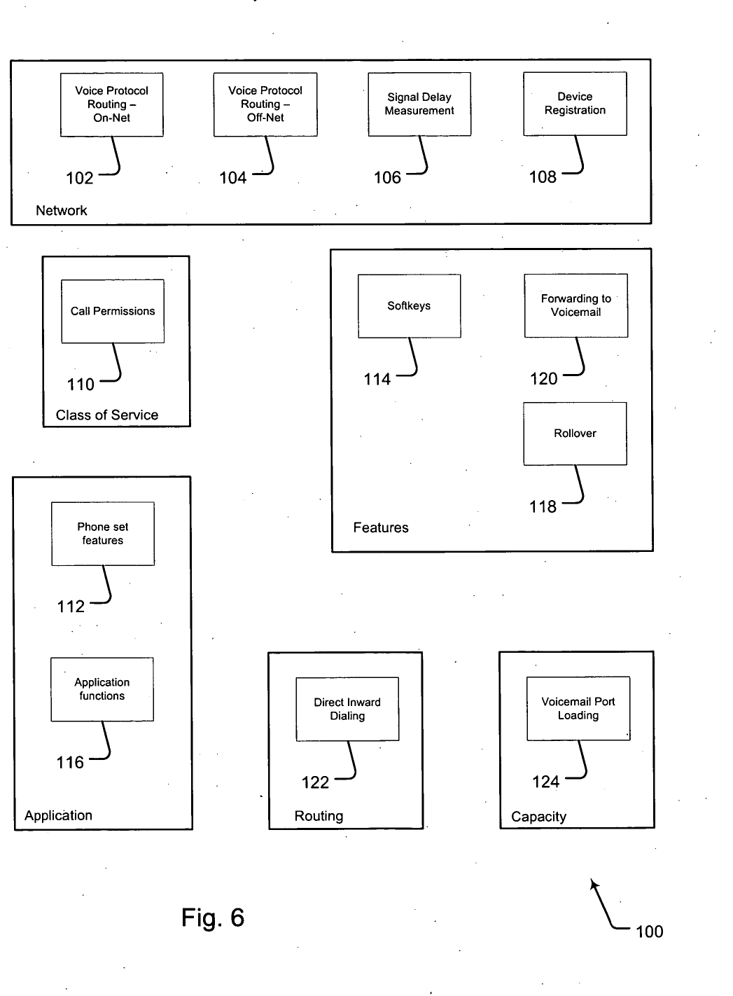

The set of components shown in FIG. 5 is comprehensive, and for that reason it can be cumbersome for a test designer to work with. It is thus highly useful to categorize the test components into groups of functionally related components, as depicted at step 21, FIG. 3. Such a categorization is shown in FIG. 6, in which the components are grouped into six categories. The network functions category 150 includes the voice routing protocol components 102 and 104, the signal delay measurement component 106 and device registration component 108. Class of service category 152 comprises only the call permissions component 110.

Taken together, the categories set out above form a generic test plan 100. It should be understood that the generic test plan illustrated here is not the only such plan that could be assembled, but it does include a complete set of test components required to test a network-based telephone system both for certification and operational purposes.

The hierarchical structure that results from categorization shown in FIG. 6 lends itself to straightforward automation. A user desiring to build a test plan for a particular site or network can select particular test components, specify test elements, parameters and dependencies, and proceed to run the tests. Such tests can be saved for running at scheduled times, or tests can be structured for identified contingencies.

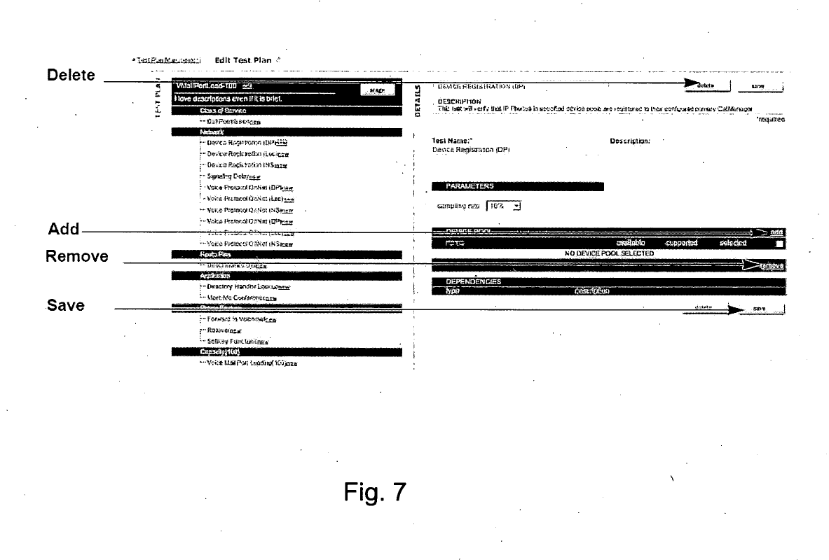

The screenshot of FIG. 7 illustrates such a system in operation. As can be seen, the test categories and components are shown in hierarchical menu form in the pull-down menu at the left side of the screen. The specifics of a device registration component are being worked on by the user, with capability to edit the component fully as needed.

The present invention may be characterized from the perspective of the system, as opposed to the method for building the system. From this perspective, the present invention includes a hierarchical structure of functional categories, each of which includes one or more test components. In turn, each test component includes a functional aspect as well as test elements, parameters and dependencies.

While the present invention is disclosed by reference to the preferred embodiments and examples detailed above, it is understood that these examples are intended in an illustrative rather than in a limiting sense. Computer-assisted processing is implicated in the described embodiments. Accordingly, the present invention may be embodied in methods for building a generic system for testing network-based telephony systems; systems including logic and resources to carry out testing of network-based telephony systems; systems that take advantage of computer-assisted testing of network-based telephony systems; media impressed with logic to carry out testing of network-based telephony systems; data streams impressed with logic to carry out testing of network-based telephony systems; or computer-accessible services that carry out computer-assisted testing of network-based telephony systems. It is contemplated that modifications and combinations will readily occur to those skilled in the art, which modifications and combinations will be within the spirit of the invention and the scope of the following claims.

We claim as follows:

1. Assembling a generic system for testing a network-based telephony system, comprising the steps of:
abstracting required performance characteristics of a network-based telephony system;
for each functional element of abstracted characteristics, separating generic characteristics from implementation-specific performance characteristics of the network;
constructing test components addressing each functional element;
assembling the test components into a unified set, including enabling configuration of each template to accommodate specific network implementations.

2. The method of claim 1, wherein each test component further includes provision for test elements, test parameters and test dependencies, enabling the customization of a generic system to a specific network-based environment.

3. The method of claim 1, wherein the test components are further grouped into categories of network functionality.

4. The method of claim 3, wherein the categories include at least network functions, class of service functions, application functionality, routing, phone features and capacity categories.

5. The method of claim 1, wherein the generic system is completely operable on a computer system.

6. The method of claim 1, wherein the unified set of test procedures is incorporated into a machine-operable test system.

7. The method of claim 1, wherein the generic system is contained in machine-readable form.

8. The method of claim 2, wherein the customization proceeds under computer control.

9. A generic system for testing a network-based telephone system, including
test components, each component including
functional test procedures for testing specified characteristics;
test elements specifying the class of items suitable for testing by the component;
test parameters for specifying selected characteristics of the functional test procedures;
test dependencies identifying prerequisites for conducting the test.

10. The method of claim 9, wherein the test components are adapted for operation on a computer.

11. The method of claim 9, wherein the unified set of test procedures is incorporated into a machine-operable test system.

12. The method of claim 9, wherein the generic system is contained in machine-readable form.

13. Devising a system for testing a network-based telephony system, comprising the steps of:
receiving a generic network-based telephony test regime in machine readable form, which regime include required performance characteristics of a network-based telephony system;
developing a preliminary test plan by modifying the generic regime to fit the same to the overall characteristics of the specific system, the overall characteristics of the implementing organization, and the implementation goals of the implementing organization;
adapting the preliminary test plan into a detailed test plan, including the steps of identifying implementation-specific performance characteristics of the network;
constructing test components addressing each functional element;
assembling the test components into a unified set, including enabling configuration to accommodate specific network implementations.

14. The method of claim 13, wherein each test component further includes provision for test elements, test parameters and test dependencies, enabling the customization of a generic system to a specific network-based environment.

15. The method of claim 13, wherein the test components are further grouped into categories of network functionality.

16. The method of claim 15, wherein the categories include at least network functions, class of service functions, application functionality, routing, phone features and capacity categories.
